(19) United States
(12) Patent Application Publication
(10) Pub. No.: US 2020/0004785 A1
(43) Pub. Date: Jan. 2, 2020

(54) AUTOMATIC GROUPING BASED ON USER BEHAVIOR

(71) Applicant: Shanghai Bilibili Technology Co., Ltd., Shanghai (CN)

(72) Inventors: Zuojian Tian, Shanghai (CN); Lijun Duan, Shanghai (CN)

(21) Appl. No.: 16/452,458

(22) Filed: Jun. 25, 2019

(30) Foreign Application Priority Data
Jun. 29, 2018 (CN) 201810718843.3

(51) Int. Cl. G06F 16/906; H04L 12/58

(52) U.S. Cl. CPC G06F 16/906; H04L 51/32

(57) ABSTRACT

Techniques for automatically grouping users in a network community are described herein. The disclosed techniques include receiving at least one virtual resource from a user; determining that a virtual identity has a value parameter equivalent to the at least one virtual resource in response to a first operation triggered by the user; sending the virtual identity to a resource repository associated with the user; presenting the virtual identity in a first predetermined area in response to detecting a second operation triggered by the user; determining whether at least one group has a same attribute as the virtual identity displayed in the first predetermined area; and adding the user into the at least one group in response to a determination that the at least one group has the same attribute as the virtual identify.

### CROSS-REFERENCE TO RELATED APPLICATION

The present application claims priority of Chinese patent application No. 201810718843.3, filed on Jun. 29, 2018. The entire disclosure of the above-identified application is hereby incorporated by reference herein and made a part of this specification.

### BACKGROUND

Instant messaging (IM for short) refers to the business that can achieve instant data transmission through the Internet. Instant messaging group (IM group for short) is an important business function in the instant messaging service, this function is used to do the group message business, can realize multi-party instant messaging communication and resource information sharing among multiple instant messaging users, and brings more convenient and richer information exchange business experience for the instant messaging users.

In the current network community, people attributes can be divided into idols and fans. In this scenario, people gathered around idols can establish communication groups. After the communication groups are established, ordinary fans need to find their idol groups and apply to join. In the existing network community, the user's group adding process needs to go through a series of links such as user searching, applying to join, administrator validation and so on, the process is complex and the response speed is slow, which make the experience of the user, whose requirement to the timeliness of group information is higher, worse. For example, one idol is broadcasting live, one user is eager to add group quickly to facilitate real-time interaction, but the group adding process often needs to go through a long waiting time, which affects the user experience.

As to the problems that the group adding process of the social network users in the prior art is complex and the corresponding response speed is slow, no effective solution has been put forward.

### BRIEF DESCRIPTION OF THE DRAWINGS

FIG. 1 is a flowchart illustrating an example process of automatic grouping users in a network community in accordance with the present disclosure.

FIG. 2 is a schematic diagram illustrating an example device of automatic grouping users in a network community in accordance with the present disclosure.

FIG. 3 is a schematic diagram illustrating a further example device of automatic grouping users in a network community in accordance with the present disclosure.

FIG. 4 is a schematic diagram illustrating an example computing device that may be used in accordance with the present disclosure.

### DETAILED DESCRIPTION OF ILLUSTRATIVE EMBODIMENTS

In the disclosure, it is achieved that grouping users is controlled based on the user behaviors. Specifically, with the help of the preset virtual identity as the influence factor of the group adding control signal, the user can trigger the group adding control signal by presenting his own virtual identity in the virtual identity display area. According to the attribute of the virtual identity presented by the user, the ID corresponding to the user is automatically added in the group matching with the attribute of the virtual identity of the user, to achieve the effect of automatically adding the user to the group according to his interest. The present disclosure effectively solves the problems that the group adding process of the social network users in the prior art is complex and the corresponding response speed is slow, improves the user's group adding speed, reduces the complexity of the user's group adding process, and furthermore improves the user experience.

In order to make the objective, the technical solutions and the advantages of the present disclosure clearer and more understandable, the present disclosure is further illustrated in detail by combining the following embodiments with the accompanying drawings. It should be understood that, the specific embodiments described herein are used only to explain the disclosure and not to limit the disclosure. Based on the embodiments of the disclosure, all other embodiments obtained by the ordinary technicians skilled in the art without any creative work belong to the protection scope of the disclosure.

Considering that in the existing network community, the user's group adding process needs to go through a series of links such as user searching, applying to join, administrator validation and so on, the process is complex and the response speed is slow, which make the experience of the user, whose requirement to the timeliness of group information is higher, worse. The disclosure provides a user-behavior-based automatic group adding control solution. The user-behavior-based automatic group adding control solution of the disclosure applies to the fields of the Internet technology and the instant messaging technology. The disclosure achieves that the user's IM group adding process is controlled based on the user's behavior. Specifically, with the help of the preset virtual identity as the influence factor of the group adding control signal, the user can trigger the group adding control signal by wearing his own virtual identity in the virtual identity display area. According to the attribute of the virtual identity worn by the user, the ID corresponding to the user is automatically added in the group matching with the attribute of the virtual identity he wears, to achieve the effect of automatically adding the user to the group according to his interest. This group adding control method effectively solves the problems that the group adding process of the social network users in the prior art is complex and the corresponding response speed is slow, improves the user's group adding speed, reduces the complexity of the user's group adding process, and furthermore improves the user experience.

Hereinafter the disclosure is illustrated in detail:

### Embodiment 1

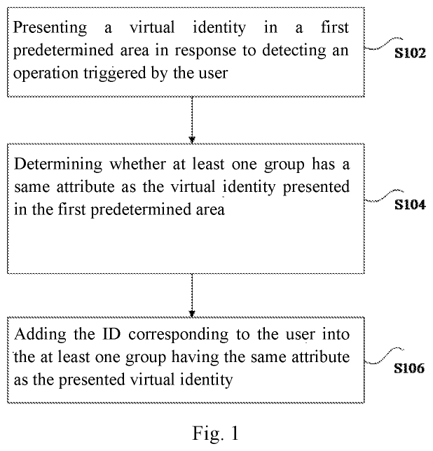

FIG. 1 illustrates an example method of automatically grouping users in a network community in accordance with the present disclosure. Preferably, the present method can be applied to the server side, for example, the server side of an instant messaging software or a network platform such as a video website, a network community, etc., when it is implemented, the present method may comprise the following steps S102-S106:

S102, in response to an operation representing wearing a virtual identity triggered by a user, presenting the virtual identity in a predetermined virtual identity display area;

When one user carries out corresponding operations on a client end or a terminal end, they can obtain various network functions provided by the background server, and one of the functions is that the user can wear virtual identities in his own resource repository. When the user triggers the operation of wearing a virtual identity that already exists in his own resource repository, the virtual identity can be displayed in the preset virtual identity display area.

Wherein, preferably, the virtual identity can be a network logo such as a medal, a headgear, etc.

Before the above mentioned step S102 of responding to an operation representing wearing a virtual identity triggered by a user, the virtual identity having the same attribute relationship as the group published in advance in the trading area by an administrator having a first administrative authority to the group can be obtained; taking the network community application scenario as an example, the community operation company can act as the above mentioned administrator having the first administrative authority to the group to publish the virtual identity as an agent. After the server obtains the published virtual identity, the user can exchange the virtual identity in the exchange area provided by the server. Specifically, the background server responds to an operation representing exchanging the virtual identity triggered by the user in the terminal end and exchanges the virtual identity. In the implementation, the virtual identity having the value parameter equivalent to a virtual resource provided by the user is sent to a resource repository of the ID corresponding to the user, wherein the virtual resource is obtained when the user's daily behavior matches a preset resource obtaining behavior. Taking the network community application scenario as an example, the user obtains a virtual resource having a common attribute with an equivalent value parameter through community public operations such as sign-in and posting, when the user purchases a peripheral product having a specific attribute, he obtains a virtual resource having a specific attribute with an equivalent value parameter, as a priority, a virtual resource having a common attribute can exchange a virtual identity having any attribute, a virtual resource having a specific attribute can exchange only a virtual identity in a specific field corresponding to the virtual resource.

S104, in response to detecting that the virtual identity is presented in the predetermined virtual identity display area, determining whether at least one group has a same attribute as the virtual identity presented in the predetermined virtual identity display area;

When the user triggers the operation of wearing a virtual identity that already exists in his own resource repository, the background server will display the virtual identity in the preset virtual identity display area, at this time, the monitoring process triggers the automatic group adding control process and screens out a group having the same attribute relationship as the virtual identity displayed in the current display area, after monitoring that the virtual identity is displayed in the virtual identity display area, for example, fans wear a medal having an idol or anchor attribute in the network community, and the group screened out is the group of the idol or the anchor.

S106, adding the ID corresponding to the user into the group having the same attribute relationship as the presented virtual identity.

In the implementation as mentioned above, it is achieved that the user's IM group adding process is controlled based on the user's behavior. Specifically, with the help of the preset virtual identity as the influence factor of the group adding control signal, the user can trigger the group adding control signal by wearing his own virtual identity in the virtual identity display area. According to the attribute of the virtual identity worn by the user, the ID corresponding to the user is automatically added in the group matching with the attribute of the virtual identity he wears, to achieve the effect of automatically adding the user to the group according to his interest. This group adding control method effectively solves the problems that the group adding process of the social network users in the prior art is complex and the corresponding response speed is slow, improves the user's group adding speed, reduces the complexity of the user's group adding process, and furthermore improves the user experience.

In an optional implementation, the group adding process can be controlled according to the screening result of screening out the group, specifically, when the screening result of screening out a group having the same attribute relationship as the virtual identity displayed is empty, that is to say, the group corresponding to the virtual medal displayed in the current display area is not found, the following logic can be performed: searching and determining the number of the users wearing the virtual identity same to the virtual identity displayed currently in the virtual identity display area among all users; determining whether the number of the users determined meets the threshold of establishing a new group or not; establishing the new group having the same attribute relationship as the virtual identity worn currently, when the number of the users determined meets the threshold of establishing a new group.

For example, if what is displayed by a user in the display area is a medal of A anchor, but the group of A anchor is not screened out, the background server determines the number of the users displaying the medal of A anchor in the display area, when the number of the users exceeds the preset threshold (e.g. 20), it is judged that the number of the people for establishing a group is satisfied, and a new group having A anchor is established, all users displaying the medal of A anchor in the current display area are added into the new group established.

In another optional implementation, when the group adding process is controlled according to the screening result of screening out the group, when the screening result of screening out the group having the same attribute relationship as the virtual identity displayed is not empty, the proportion of the people in the group screened out is obtained; the target group to which the user triggering the operation of wearing a virtual identity belongs is determined according to the proportion of the people.

For example, if what is displayed by a user in the display area is a medal of A anchor, multiple groups are screened out, the proportion of the people in each group can be calculated definitely, for example, the maximum number of the people in group a1 is 100, the current actual number of the people in group a1 is 70, then the proportion of the people is 70%, the maximum number of the people in group a2 is 100, the current actual number of the people in group a2 is 95, then the proportion of the people is 95%, the maximum number of the people in group a3 is 100, the current actual number of the people in group a3 is 80, then the proportion of the people is 80%, in the target group allocation, the people should be allocated firstly to the group (a1) with the minimum proportion of the people, when the minimum proportion of the people increases as the people allocated increases and is not the minimum proportion of the people (for example, the number of the people in group a1 reaches 81, and is greater than that in group a3), the people are allocated to the group (a3) with the new minimum proportion of the people, and so on.

In addition, in a preferred implementation of the disclosure, the above mentioned technical solution is further optimized, specifically, after the step of adding the ID corresponding to the user into the group having the same attribute relationship as the virtual identity displayed, a reminder message preset by an administrator having a second administrative authority to the group is obtained; the reminder message is pushed to the group, when a preset time threshold is passed by after the ID corresponding to the user is added into the group having the same attribute relationship as the virtual identity displayed.

For example, after the user is added to the group, the system sends a welcome message, which can be set by the group host (for example, the anchor). Taking Zhang San as an example, a message “Welcome Zhang San into the group” posted by the idol anchor of the user will appear in the group, which will further enhance the user experience.

### Embodiment 2

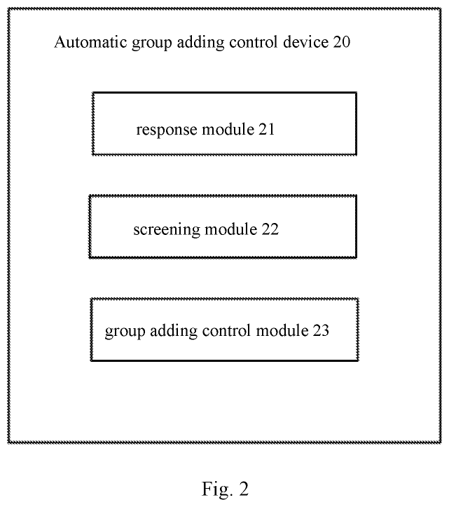

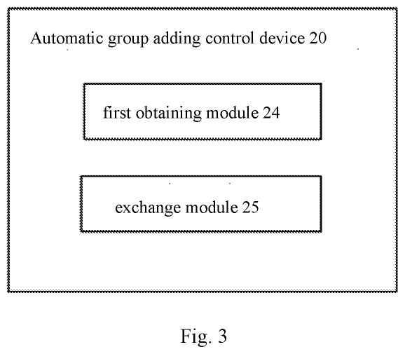

Based on the automatic group adding control method provided in Embodiment 1, a user-behavior-based automatic group adding control device is provided in the present embodiment, specifically, FIG. 2-3 show an optional block diagram of the user-behavior-based automatic group adding control device, as shown in FIG. 2, the user-behavior-based automatic group adding control device 20 comprises:

a response module 21, used to respond to an operation representing wearing a virtual identity triggered by a user, and present the virtual identity in a preset virtual identity display area;

a screening module 22, used to monitor and detect that the virtual identity is presented in the virtual identity display area, and identify a group having the same attribute relationship as the virtual identity displayed;

a group adding control module 23, used to add the ID corresponding to the user into the group having the same attribute relationship as the virtual identity displayed.

In the alternative implementation as described above, it is achieved that the user's IM group adding process is controlled based on the user's behavior. Specifically, with the help of the preset virtual identity as the influence factor of the group adding control signal, the user can trigger the group adding control signal by wearing his own virtual identity in the virtual identity display area. According to the attribute of the virtual identity worn by the user, the ID corresponding to the user is automatically added in the group matching with the attribute of the virtual identity he wears, to achieve the effect of automatically adding the user to the group according to his interest. This group adding control method effectively solves the problems that the group adding process of the social network users in the prior art is complex and the corresponding response speed is slow, improves the user's group adding speed, reduces the complexity of the user's group adding process, and furthermore improves the user experience.

Furthermore, as shown in FIG. 3, the user-behavior-based automatic group adding control device 20 further comprises:

a first obtaining module 24, used to obtain the virtual identity having the same attribute relationship as the group published in advance in the trading area by an administrator having a first administrative authority to the group, before the step of responding to an operation representing wearing a virtual identity triggered by a user;

an exchange module 25, used to respond to an operation representing exchanging the virtual identity triggered by the user, and send the virtual identity having the value parameter equivalent to a virtual resource provided by the user to a resource repository of the ID corresponding to the user, wherein the virtual resource is obtained when the user's daily behavior matches a preset resource obtaining behavior.

Furthermore, the screening module comprises:

a first determination unit, used to search and determine the number of the users wearing the virtual identity same to the virtual identity displayed currently in the virtual identity display area among all users, when the screening result of screening out a group having the same attribute relationship as the virtual identity displayed is empty;

a second determination unit, used to determine whether the number of the users determined meets the threshold of establishing a new group or not;

a new group establishing control unit, used to establish the new group having the same attribute relationship as the virtual identity worn currently, when the number of the users determined meets the threshold of establishing a new group.

Furthermore, the group adding control module comprises:

an obtaining unit, used to obtain the proportion of the people in the group screened out, when the screening result of screening out a group having the same attribute relationship as the virtual identity displayed is not empty;

a third determination unit, used to determine the target group to which the user triggering the operation of wearing a virtual identity belongs according to the proportion of the people.

Furthermore, the device further comprises:

a second obtaining module, used to obtain a reminder message preset by an administrator having a second administrative authority to the group, after the step of adding the ID corresponding to the user into the group having the same attribute relationship as the virtual identity displayed;

a pushing module, used to push the reminder message to the group, when a preset time threshold is passed by after the ID corresponding to the user is added into the group having the same attribute relationship.

With regard to the device in the embodiment as described above, the specific ways in which the units and the modules perform operations have been described in details in the embodiment of the method, and will not be described in details here.

### Embodiment 3

The disclosure also provides a computer device, comprising a storage, a processor and a computer program that is stored on the storage and can be run on the processor, the steps of the user-behavior-based automatic group adding control method mentioned above are implemented when the computer program is executed by the processor.

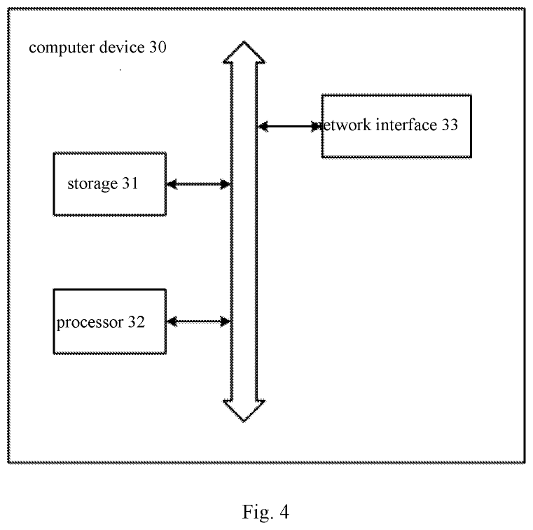

A computer device is provided in the preferred Embodiment 3 of the disclosure. FIG. 4 is a hardware architecture schematic diagram according to the embodiment of the computer device of the disclosure. In the present embodiment, the computer device 30 is a device capable of automatically performing numerical calculation and/or information processing according to preset or stored instructions. For example, it can be a smartphone, a tablet, a laptop, a desktop computer, a rack server, a blade server, a tower server or a cabinet server (including an independent server, or a server cluster composed of multiple servers), etc. As shown in the figure, the computer device 30 includes at least but is not limited to: at least one storage 31, at least one at least one processor 32, at least one network interface 33 that can be communicated with each other through the system bus. Wherein:

The at least one storage 31 includes at least one type of computer-readable storage media which include a flash memory, a hard disk, a multimedia card, a card type memory (e.g., SD or DX memory, etc.), a random access memory (RAM), a static random access memory (SRAM), a read-only memory (ROM), an electrically erasable programmable read-only memory (EEPROM), a programmable read-only memory (PROM), a magnetic memory, a disk, a CD, etc. In some embodiments, the at least one storage 31 may be an internal storage module of the computer device 30, such as the hard disk or the memory of the computer device 30. In other embodiments, the at least one storage 31 can also be an external storage device of the computer device 30, such as a plug-in hard disk, a Smart Media Card (SMC), a Secure Digital (SD) card, a Flash Card, etc. equipped on the computer device 30. Of course, the at least one storage 31 can also include both the internal storage module and the external storage device of the computer device 30. In the present embodiment, the at least one storage 31 is usually used to store the operating system and various application software installed in the computer device 30, such as the program code of the automatic group adding control method, etc. In addition, the at least one storage 31 can also be used to temporarily store various types of data that have been or will be output.

In some embodiments, the at least one at least one processor 32 may be a central processing unit (CPU), a controller, a microcontroller, a microprocessor, or another data processing chip. The at least one at least one processor 32 is usually used to control the overall operation of the computer device 30, such as performing the controls and the processes related to data interaction or communication with the computer device 30. In the present embodiment, the at least one at least one processor 32 is used to run the program code stored in the at least one storage 31 or process data.

The at least one network interface 33 may include a wireless network interface or a wired network interface, and is commonly used to establish a communication connection between the computer device 30 and another computer device. For example, the at least one network interface 33 is used to connect the computer device 30 with an external terminal end through the network, establish a data transmission channel, a communication connection, etc., between the computer device 30 and the external terminal end. The network can be a wireless or wired network such as the Intranet, the Internet, the Global System of Mobile Communication (GSM), the Wideband Code Division Multiple Access (WCDMA), the 4G network, the 5G network, the Bluetooth and the Wi-Fi.

It should be pointed out that, FIG. 4 only shows the computer device with the components 21-23, but it should be understood that, not all components shown are required to be implemented, and more or fewer components can be implemented alternatively.

In the present embodiment, the user-behavior-based automatic group adding control method stored in the at least one storage 31 can also be divided into one or more program modules and executed by one or more processors (the at least one processor 32 in the present embodiment), so as to complete the disclosure.

### Embodiment 4

The disclosure also provides a computer-readable storage medium, on which a computer program is stored, wherein, the steps of the user-behavior-based automatic group adding control method mentioned above are implemented when the computer program is executed by a processor.

In the present embodiment, the computer-readable storage medium includes a flash memory, a hard disk, a multimedia card, a card type memory (e.g., SD or DX memory, etc.), a random access memory (RAM), a static random access memory (SRAM), a read-only memory (ROM), an electrically erasable programmable read-only memory (EEPROM), a programmable read-only memory (PROM), a magnetic memory, a disk, a CD, etc. In some embodiments, the computer-readable storage medium may be an internal storage module of the computer device, such as the hard disk or the memory of the computer device. In other embodiments, the computer-readable storage medium can also be an external storage device of the computer device, such as a plug-in hard disk, a Smart Media Card (SMC), a Secure Digital (SD) card, a Flash Card, etc. equipped on the computer device. Of course, the computer-readable storage medium can also include both the internal storage module and the external storage device of the computer device. In the present embodiment, the computer-readable storage medium is usually used to store the operating system and various application softwares installed in the computer device, such as the program code of the user-behavior-based automatic group adding control method in Embodiment 1, etc. In addition, the computer-readable storage medium can also be used to temporarily store various types of data that have been or will be output.

Obviously, it should be understood by those technicians skilled in the art that the modules or the steps of the above mentioned embodiments of the disclosure can be implemented by a general computing device, can be integrated on a single computing device or distributed on a network composed of multiple computing devices, and optionally, they can be implemented by program codes that can be executed by a computing device, so that they can be stored in a storage device and executed by a computing device, and in some cases, the steps shown or described here may be performed in a different order, or they may be manufactured into integrated circuit modules respectively, or multiple modules or steps among them may be manufactured into a single integrated circuit module. Thus, the embodiments of the disclosure are not limited to any particular hardware and software combination.

The above-mentioned embodiments are only preferred embodiments of the disclosure, and therefore do not limit the patent scope of the disclosure. Any equivalent structure or process transformation made by using the contents of the specification and the drawings of the disclosure, and directly or indirectly applying them in other related technical fields, are equally included in the patent protection scope of the disclosure.

What is claimed is:

1. A method of automatically grouping users in a network community, comprising:
receiving at least one virtual resource from a user;
determining that a virtual identity has a value parameter equivalent to the at least one virtual resource in response to a first operation triggered by the user;
sending the virtual identity to a resource repository associated with the user;
presenting the virtual identity in a first predetermined area in response to detecting a second operation triggered by the user;
determining whether at least one group has a same attribute as the virtual identity displayed in the first predetermined area; and
adding the user into the at least one group in response to a determination that the at least one group has the same attribute as the virtual identify.

2. The method of claim 1, wherein the at least one virtual resource is obtained by the user based on the user's behaviors in the network community and one or more predetermined rules.

3. The method of claim 1, wherein the virtual identity is among a plurality of virtual identities that are published in a second predetermined area by a first administrator of the network community.

4. The method of claim 1, further comprising:
determining a number of users in the network community who has triggered the second operation in response to a determination that the at least one group does not exist in the network community;
determining whether the number of the users satisfies a predetermined threshold of generating a new group in the network community that has the same attribute as the virtual identity; and
generating the new group in response to a determination that the number of the users satisfies the predetermined threshold.

5. The method of claim 1, further comprising:
in response to a determination that the at least one group comprises a plurality of groups, determining a plurality of proportions corresponding to the plurality of groups, wherein each proportion is determined based on an actual number of users that each corresponding group currently contains and a maximum number of users that each corresponding group is capable of containing.

6. The method of claim 5, further comprising:
determining a minimum proportion among the plurality of proportions; and
adding the user into a group among the plurality groups that has the minimum proportion.

7. The method of claim 1, further comprising:
obtaining a message preset by a second administrator of the network community; and
sending the message among the at least one group after adding the user into the at least one group.

8. A system of automatically grouping users in a network community, comprising:
at least one processor; and
at least one memory communicatively coupled to the at least one processor and storing instructions that upon execution by the at least one processor cause the system to:
receive at least one virtual resource from a user;
determine that a virtual identity has a value parameter equivalent to the at least one virtual resource in response to a first operation triggered by the user;
send the virtual identity to a resource repository associated with the user;
present the virtual identity in a first predetermined area in response to detecting a second operation triggered by the user;
determine whether at least one group has a same attribute as the virtual identity displayed in the first predetermined area; and
add the user into the at least one group in response to a determination that the at least one group has the same attribute as the virtual identify.

9. The system of claim 8, wherein the at least one virtual resource is obtained by the user based on the user's behaviors in the network community and one or more predetermined rules.

10. The system of claim 8, wherein the virtual identity is among a plurality of virtual identities that are published in a second predetermined area by a first administrator of the network community.

11. The system of claim 8, the at least one memory further storing instructions that upon execution by the at least one processor cause the system to:
determine a number of users in the network community who has triggered the second operation in response to a determination that the at least one group does not exist in the network community;
determine whether the number of the users satisfies a predetermined threshold of generating a new group in the network community that has the same attribute as the virtual identity; and
generate the new group in response to a determination that the number of the users satisfies the predetermined threshold.

12. The system of claim 8, the at least one memory further storing instructions that upon execution by the at least one processor cause the system to:
in response to a determination that the at least one group comprises a plurality of groups, determine a plurality of proportions corresponding to the plurality of groups, wherein each proportion is determined based on an actual number of users that each corresponding group currently contains and a maximum number of users that each corresponding group is capable of containing.

13. The system of claim 12, the at least one memory further storing instructions that upon execution by the at least one processor cause the system to:
determine a minimum proportion among the plurality of proportions; and
add the user into a group among the plurality groups that has the minimum proportion.

14. The system of claim 8, the at least one memory further storing instructions that upon execution by the at least one processor cause the system to:
obtain a message preset by a second administrator of the network community; and
send the message among the at least one group after adding the user into the at least one group.

15. A non-transitory computer-readable storage medium comprising computer-readable instructions that upon execution on a computing device cause the computing device at least to:
receive at least one virtual resource from a user;
determine that a virtual identity has a value parameter equivalent to the at least one virtual resource in response to a first operation triggered by the user;
send the virtual identity to a resource repository associated with the user;
present the virtual identity in a first predetermined area in response to detecting a second operation triggered by the user;
determine whether at least one group has a same attribute as the virtual identity displayed in the first predetermined area; and
add the user into the at least one group in response to a determination that the at least one group has the same attribute as the virtual identify.

16. The non-transitory computer-readable storage medium of claim 15, wherein the at least one virtual resource is obtained by the user based on the user's behaviors in the network community and one or more predetermined rules.

17. The non-transitory computer-readable storage medium of claim 15, further comprising computer-readable instructions that upon execution on the computing device cause the computing device at least to:
determine a number of users in the network community who has triggered the second operation in response to a determination that the at least one group does not exist in the network community;
determine whether the number of the users satisfies a predetermined threshold of generating a new group in the network community that has the same attribute as the virtual identity; and
generate the new group in response to a determination that the number of the users satisfies the predetermined threshold.

18. The non-transitory computer-readable storage medium of claim 15, further comprising computer-readable instructions that upon execution on the computing device cause the computing device at least to:
in response to a determination that the at least one group comprises a plurality of groups, determine a plurality of proportions corresponding to the plurality of groups, wherein each proportion is determined based on an actual number of users that each corresponding group currently contains and a maximum number of users that each corresponding group is capable of containing.

19. The non-transitory computer-readable storage medium of claim 18, further comprising computer-readable instructions that upon execution on the computing device cause the computing device at least to:
determine a minimum proportion among the plurality of proportions; and
add the user into a group among the plurality groups that has the minimum proportion.

20. The non-transitory computer-readable storage medium of claim 15, further comprising computer-readable instructions that upon execution on the computing device cause the computing device at least to:
obtain a message preset by a second administrator of the network community; and
send the message among the at least one group after adding the user into the at least one group.
